(19) United States
(12) Patent Application Publication
(10) Pub. No.: US 2026/0211126 A1
(43) Pub. Date: Jul. 23, 2026

(54) POSITIONING DEVICE AND METHOD AND MOVING BODY INCLUDING THE SAME

(71) Applicant: HL MANDO CORPORATION, Pyeongtaek-si (KR)

(72) Inventor: Ingu CHOI, Pyeongtaek-si (KR)

(73) Assignee: HL MANDO CORPORATION, Pyeongtaek-si (KR)

(21) Appl. No.: 19/455,063

(22) Filed: Jan. 21, 2026

(30) Foreign Application Priority Data
Jan. 23, 2025 (KR) 10-2025-0010211
Sep. 4, 2025 (KR) 10-2025-0125414

(51) Int. Cl. G01S 19/47

(52) U.S. Cl. CPC G01S 19/47

(57) ABSTRACT

Disclosed herein are a positioning device, a positioning method, and a moving body including the same. The positioning device includes a global navigation satellite system (GNSS) module including a first GNSS module and a second GNSS module, an inertial measurement unit (IMU) including an acceleration sensor and an angular velocity sensor, a wheel encoder configured to detect an amount of rotation of two or more wheels of a moving body, and a positioning module. The positioning module is configured to determine first position information in a first area where in which a GNSS signal is received and second position information in a second area in which a GNSS signal is not received, using a first GNSS measurement value and a second GNSS measurement value determined based on GNSS signals from the GNSS module, inertial measurement values from the IMU, and wheel encoding measurement values from the wheel encoder.

### CROSS-REFERENCE TO RELATED APPLICATION

This application claims priority from Korean Patent Application No. 10-2025-0010211 filed on Jan. 23, 2025, and Korean Patent Application No. 10-2025-0125414 filed on Sep. 4, 2025, which are hereby incorporated by reference for all purposes as if fully set forth herein.

### BACKGROUND

### Technical Field

Embodiments of the present disclosure relate to a positioning device and method for determining a position, and a moving body including the same. More specifically, embodiments of the present disclosure relate to a hybrid positioning device and method for a moving body such as an autonomous vehicle or a robot, and relate to a hybrid positioning device and method using a Global Navigation Satellite System (hereinafter also referred to as “GNSS”) module, an Inertial Measurement Unit (hereinafter also referred to as “IMU”), and a wheel encoder.

### Description of the Related Art

Currently, various positioning methods are used to accurately measure the position of moving bodies such as vehicles or robots.

Among these, GNSS positioning, which determines longitude/latitude on Earth based on information from three or more positioning satellites, is widely used.

However, because GNSS requires receiving multiple satellite signals, the GNSS may not operate in signal-shadowed areas such as tunnels and indoors.

To address these GNSS shortcomings, methods are being considered that utilize inertial measurement devices, such as acceleration sensors and angular velocity sensors (e.g., gyroscopes) within a vehicle to correct or assist positioning.

However, a hybrid positioning method or a positioning fusion method currently being developed have the problem of making it difficult to accurately measure the indoor position of moving bodies such as vehicles or robots.

### BRIEF SUMMARY

The present disclosure is directed to a hybrid positioning architecture that uses two spatially separated GNSS modules not only to determine position but also to calculate the yaw or heading of a moving body based on relative GNSS coordinate geometry. By deriving an absolute yaw reference from dual GNSS measurements in environments where satellite signals are available, the system reduces reliance on inertial integration and limits long term drift associated with single GNSS or IMU based heading estimation.

The present disclosure further addresses differentiated positioning operation based on signal availability by explicitly determining whether the moving body is located in a GNSS reception area or a GNSS shadow area. In a GNSS reception area, position is determined using a first fusion function that combines GNSS position data, yaw derived from the two GNSS modules, inertial measurement data, and wheel encoder based forward kinematics. In a GNSS shadow area, position is determined using a second fusion function that propagates motion using forward kinematics and inertial data initialized from the last position determined in the GNSS reception area.

In addition, the present disclosure provides a structured transition mechanism between the two positioning modes to preserve positional continuity. Position updates are generated using incremental transformation matrices that are anchored to GNSS based position updates when available and are cumulatively applied when GNSS signals are unavailable. During transitions between GNSS reception areas and GNSS shadow areas, continuity checks and adaptive measurement weighting are used to maintain stable and consistent position outputs within a unified UTM (Universal Transverse Mercator) coordinate framework.

Various embodiments of the present disclosure provide a hybrid positioning device and method capable of producing precise position information in all environments, both indoors and outdoors, for a moving body such as a vehicle or robot, and a moving body including the same.

Various embodiments of the present disclosure provide a hybrid positioning device and method capable of calculating precise position information of a moving body even in a shadow area of GNSS signals by using information from two GNSS modules, an IMU device, and a wheel encoder installed in the moving body, and a moving body including the same.

In accordance with an aspect of the present disclosure, an embodiment may provide a positioning device including a global navigation satellite system (GNSS) module including a first GNSS module and a second GNSS module, an inertial measurement unit (IMU) including an acceleration sensor and an angular velocity sensor, a wheel encoder for detecting an amount of rotation of a wheel of a moving body, and a positioning module configured to determine first position information in a first area where a GNSS signal is received and second position information in a second area where the GNSS signal is not received, respectively, using a first GNSS measurement value and a second GNSS measurement value determined based on GNSS signals from the GNSS module, an inertial measurement values from the IMU, and a wheel encoding measurement value from the wheel encoder for two or more wheels.

In accordance with another aspect of the present disclosure, an embodiment may provide a positioning method including receiving first latitude and longitude information from a first global navigation satellite system (GNSS) module and second latitude and longitude information from a second GNSS module, receiving an inertial measurement value from an inertial measurement unit (IMU), receiving a wheel encoding measurement value from a wheel encoder that detects an amount of rotation of a wheel of a moving body, and determining first position information in a first area where a GNSS signal is received and second position information in a second area where the GNSS signal is not received, respectively, using a first GNSS measurement value and a second GNSS measurement value determined based on the first latitude and longitude information and the second latitude and longitude information, the inertial measurement values, and the wheel encoding measurement value from the wheel encoder for two or more wheels.

In accordance with another aspect of the present disclosure, an embodiment may provide a moving body including a main body, two or more wheels provided on the main body, an autonomous driving control module that rotates the two or more wheels to move the main body along a target path, and a positioning device that measures the current position of the main body, wherein the positioning device includes a global navigation satellite system (GNSS) module including a first GNSS module and a second GNSS module, an inertial measurement unit (IMU) including an acceleration sensor and an angular velocity sensor, a wheel encoder for detecting an amount of rotation of the two or more wheels, and a positioning module configured to determine first position information in a first area where a GNSS signal is received and second position information in a second area where the GNSS signal is not received, respectively, using a first GNSS measurement value and a second GNSS measurement value determined based on GNSS signals from the GNSS module, an inertial measurement values from the IMU, and a wheel encoding measurement value from the wheel encoder for the two or more wheels.

According to embodiments of the present disclosure as described below, it is possible to provide a hybrid positioning device and method capable of producing precise position information in all environments, both indoors and outdoors, for a moving body such as a vehicle or robot, and a moving body including the same.

In addition, according to embodiments of the present disclosure, it is possible to provide a hybrid positioning device and method capable of calculating precise position information of a moving body even in a shadow area of GNSS signals by using information from two GNSS modules, an IMU device, and a wheel encoder installed in the moving body, and a moving body including the same.

### BRIEF DESCRIPTION OF THE SEVERAL VIEWS OF THE DRAWINGS

FIG. 1 schematically illustrates the configuration of a moving body to which embodiments of the present disclosure can be applied.

FIG. 2 illustrates a functional block diagram of a positioning device according to an embodiment of the present disclosure.

FIG. 3 illustrates an example of measurement values or physical quantities output from each module of a positioning device according to an embodiment of the present disclosure.

FIG. 4 illustrates a signal processing process of a positioning device according to an embodiment of the present disclosure and the resulting values from each process.

FIG. 5 is a flowchart of a positioning method according to an embodiment of the present disclosure.

FIG. 6 illustrates a functional block diagram of a moving body according to an embodiment of the present disclosure.

FIG. 7 illustrates positioning performance if an embodiment of the present disclosure is applied.

FIG. 8 illustrates an example of the hardware configuration of a positioning module according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements, etc., but is used merely to distinguish the corresponding element from other elements.

When it is mentioned that a first element “is connected or coupled to”, “contacts or overlaps”, etc., a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc., each other via a fourth element. Here, the second element may be included in at least one of two or more elements that “are connected or coupled to”, “contact or overlap”, etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

The term “unit” or “module” as used herein refers to tangible electrical circuitry and may include one or more electronic components, circuits, or assemblies of electronic components. A “unit” or “module” may be implemented as, or include, processing circuitry such as one or more processors, microprocessors, microcontrollers, integrated circuits, chips, microchips, reduced instruction set computers (RISC), application specific integrated circuits (ASICs), field programmable gate arrays (FPGAs), graphical processing units (GPUs), logic circuits, or any other hardware or circuit arrangement capable of performing the operations and functions described herein. The foregoing examples are provided for purposes of illustration only and are not intended to limit the scope or meaning of the terms “unit” or “module.”

In some embodiments, one or more units or modules described herein may be implemented by processing circuitry that executes program instructions stored in a memory or storage medium. Accordingly, a unit or module may be realized as a combination of hardware and software, where the software is executed by one or more processors to cause the processing circuitry to perform the functions described herein.

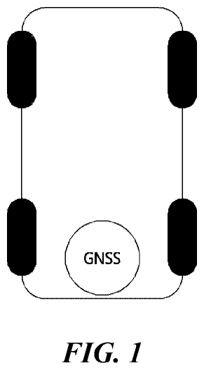

FIG. 1 schematically illustrates a configuration of a moving body or a moving object to which embodiments of the present disclosure may be applied.

A moving body to which embodiments of the present disclosure may be applied may include any moving object, mobile object, moving body, or mobile device capable of autonomous navigation, such as an autonomous vehicle or an outdoor autonomous robot.

For a moving body capable of outdoor autonomous navigation to navigate all areas of an outdoor environment, it is required to accurately determine the position of the moving body in a latitude/longitude coordinate system and a Universal Transverse Mercator (UTM) coordinate system.

Referring to FIG. 1, the moving body may utilize GPS or a Global Navigation Satellite System (GNSS) for accurate positioning.

That is, an autonomous vehicle may include an internal GPS system, use it to determine its current location, and then drive along a target route to a destination based on that location.

However, since GPS or GNSS is required to receive signals from a multiple satellites, such autonomous vehicle can only operate normally in environments where satellite signal reception is possible.

However, if a vehicle enters a shadow area of signals, such as a tunnel, it is difficult to determine its position using GPS or GNSS alone. Therefore, an inertial measurement unit (IMU) equipped on the vehicle, such as an acceleration sensor or angular velocity sensor (e.g., a gyroscope), may be additionally utilized.

Furthermore, in signal shadow areas, such as tunnels, map information included in the navigation device and vehicle speed information may be further utilized.

However, measurements from a vehicle's IMU alone can only determine the vehicle's roll, pitch, and yaw information, and do not include information regarding the vehicle's precise location, making positioning limited.

Therefore, a method for accurately determining the location of a moving body in signal shadow areas is needed.

Accordingly, embodiments of the present disclosure propose a precise positioning device and method in a signal shadow area by further utilizing a wheel encoder installed on a wheel of a moving body to measure the amount of wheel rotation in addition to a GNSS module and an IMU device.

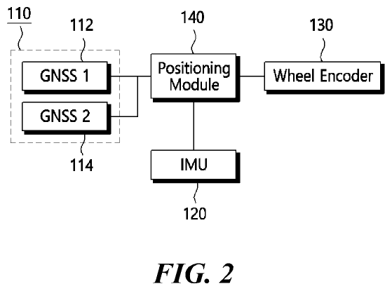

FIG. 2 illustrates a functional block diagram of a positioning device according to an embodiment of the present disclosure.

Referring to FIG. 2, a positioning device 100 according to an embodiment of the present disclosure may include a GNSS module 110 (also referred to as ‘a GNSS receiver 110’) including two GNSS modules, an inertial measurement unit (IMU) 120 (also referred to as ‘an inertial measurement unit assembly 120’ or simply ‘an inertial measurement assembly 120’), a wheel encoder 130, and a positioning module 140 (also referred to as ‘a positioning processing circuitry 140’).

The GNSS module 110 may include a first GNSS module 112 that outputs a first GNSS measurement value and a second GNSS module 114 that outputs a second GNSS measurement value.

The first GNSS module 112 and the second GNSS module 114 each may receive satellite signals from four or more satellites, such as GPS satellites, GLONASS satellites, and Galileo satellites.

The satellite signals may include location and time information for each satellite. The GNSS module may measure a distance to the satellite based on the arrival time of each signal and output position information of the GNSS module based on the relative distance of the GNSS module to three or more satellites using triangulation.

In this case, the position information output by the GNSS module may be longitude and latitude position information including longitude and latitude on the Earth.

Meanwhile, in the positioning device according to the embodiment of the present disclosure, the first GNSS measurement value may be a first UTM coordinate value

$${( x , y )}_{G NSS 1}^{U T M}$$

obtained by converting the first latitude and longitude information

$${( l at , lon )}_{G NSS 1}^{G C S}$$

measured by the first GNSS module into the Universal Transverse Mercator (UTM) coordinate system, and the second GNSS measurement value may be a second UTM coordinate value

$${( x , y )}_{GNSS 2}^{U T M}$$

obtained by converting the second latitude and longitude information measured by the second GNSS module into the UTM coordinate system.

In this case, the conversion from the latitude and longitude information into the UTM coordinate value may be performed in each GNSS module.

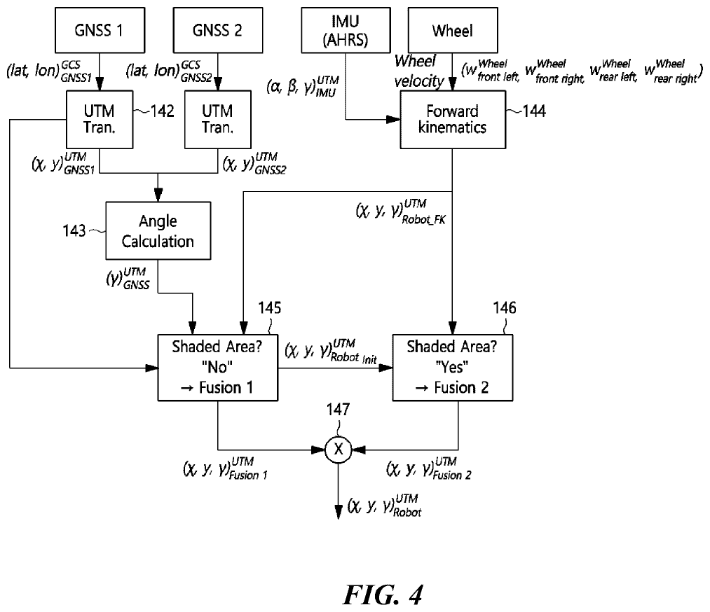

Alternatively, the conversion from latitude and longitude information to UTM coordinates may be performed by the positioning module 140 of the positioning device according to the embodiment of the present disclosure, which will be described in more detail below with reference to FIG. 4 and below.

Meanwhile, in the embodiment of the present disclosure, in order to control autonomous navigation of a moving body in a first area where satellite signal reception is possible, it is necessary to obtain not only the position of the moving body but also the heading angle or yaw measurement value of the moving body using GNSS.

Only one GNSS can determine the position of the moving body, and it is difficult to determine the direction of travel (e.g., heading angle or yaw) of the moving body.

Therefore, the positioning device according to the embodiment of the present disclosure may determine the yaw measurement value as information on the direction of travel of the moving body using the output values of two GNSS modules 112 and 114.

This function can be expressed as an angle calculation, and an angle calculation module may calculate the yaw measurement value of the moving body using the converted first UTM coordinate value

$${( x , y )}_{G NSS 1}^{U T M}$$

and second UTM coordinate value

$${( x , y )}_{G NSS 2}^{U T M} .$$

The yaw measurement value of the moving body determined in this way can be expressed as

$${( γ )}_{G N S S}^{U T M} .$$

While the positioning device 100 according to the embodiment of the present disclosure has been described as including two GNSS modules, the present disclosure is not limited thereto.

To measure the yaw or yaw rate of a moving body, two (x, y) coordinate values measured by two GNSS modules may be sufficient (for example, using a mathematical formula such as atan(dy/dx)).

However, the positioning device 100 according to the embodiment of the present disclosure may include three or more GNSS modules for more precise determination of the yaw or the yaw rate of the moving body.

For example, three or more GNSS modules may be used to compare and verify the measurement values of the GNSS modules, such as by comparing the measurement values of the GNSS modules and excluding a GNSS module with an error.

This method of determining the yaw measurement value of a moving body using such angle calculations will be described in more detail below with reference to FIG. 4 and below.

Meanwhile, the inertial measurement unit (IMU) 120 of the positioning device 100 according to an embodiment of the present disclosure may include an acceleration sensor and an angular velocity sensor, such as a gyroscope, and may determine and output an inertial measurement value of a moving body.

The acceleration sensor included in the IMU may detect acceleration due to changes in movement, such as acceleration, vibration, and impact applied to the moving body.

The acceleration value output from the acceleration sensor may be integrated to calculate the velocity of the moving body in the moving direction, which may be used to determine the position of the object.

In position determination using the acceleration sensor of the IMU, errors are small over short periods of time, but errors may accumulate over time because acceleration values are integrated for position determination.

To address this issue, the embodiment of the present disclosure may further utilize output values from the GNSS and wheel encoder to determine the position of the moving body.

Meanwhile, since it is required to further consider the gravitational acceleration, if a moving body moves while being tilted, the inclination of the moving body cannot be accurately measured with an acceleration sensor alone. To compensate for this, the IMU 120 may further include an angular velocity sensor, such as a gyroscope.

The angular velocity sensor may measure the angular velocity (unit: rad/s), which is the rotational change of the moving body, and may detect the Coiolis force using gravity.

For example, for the IMU to determine the position of the moving body, it is necessary to subtract the gravitational acceleration corresponding to the object's inclination from the determined acceleration of the moving body.

Therefore, the IMU 120 may integrate the angular velocity output from the angular velocity sensor to obtain the angle (e.g., inclination) of the moving body, and then calculate and subtract the gravitational acceleration.

Furthermore, the IMU 120 may further include a geomagnetic sensor.

A geomagnetic sensor can measure the strength (e.g., magnetic flux) and direction (e.g., the angle of deviation relative to magnetic north) of the Earth's magnetic field.

This IMU 120 may include an acceleration sensor and an angular velocity sensor, and may have a three-axis acceleration coordinate system and a three-axis angular velocity coordinate system.

In order to measure the attitude of a moving body using the angular velocity sensor and to update the attitude according to the movement of the moving body, it is necessary for the IMU 120 to integrate the rotation angle output from the angular velocity sensor with the initial roll, pitch, and yaw angles of the moving body.

Among these, roll and pitch can be obtained from the acceleration sensor, but yaw, which is most important for the movement of a moving body, cannot be calculated solely from the output of the acceleration sensor, and can be obtained by integrating the output of the angular velocity sensor.

Since the integration of the output value of the angular velocity sensor is used, the yaw value may have an accumulated error over time. To resolve this, the IMU 120 may further utilize the output value of the geomagnetic sensor and a Kalman filter, etc.

The IMU 120 of the positioning device 100 according to the embodiment of the present disclosure may use an AHRS (Attitude Reference Heading System) algorithm.

The AHRS algorithm may determine the absolute yaw angle of the moving body through a geomagnetic sensor or an additional gyroscope in addition to an ARS (Attitude Reference System) that can output the roll, pitch, and relative yaw angle of the moving body from the initial attitude.

Through the above configuration, the IMU 120 of the positioning device 100 according to the embodiment of the present disclosure may output inertial measurement values, In this case, the inertial measurement values may include the roll (α), pitch (β), and yaw (γ) values of the moving body in the UTM coordinate system, and may be expressed as

$${( α , β , γ )}_{IMU}^{UTM} .$$

The wheel encoder 130 of the positioning device 100 according to the embodiment of the present disclosure may measure the rotation angle and/or rotation angular velocity of two or more wheels provided on a main body of the moving body.

That is, in the embodiment of the present disclosure, the wheel encoding measurement values output from the wheel encoder may represent the rotation angle and/or rotation angular velocity of the wheel, and can be expressed as

$${w}_{front left}^{Wheel} .$$

In an example, a moving body may have four wheels on each side, front left, front right, rear left, and rear right, respectively.

In this case, the wheel encoding measurements may be expressed as

$${w}_{front left}^{Wheel} , {w}_{front right}^{Wheel} , {w}_{rear left}^{Wheel} , {w}_{rear right}^{Wheel} ,$$

which are the measurements for each of the four wheels.

The wheel encoder 130 may be a sensor that is fixed to the axis of a moving wheel and can measure the rotation angle and rotation velocity of the wheel. The wheel encoder 130 may be implemented as a shaft encoder or a rotary encoder, etc.

Such a wheel encoder can be implemented as one of a photoelectric rotary encoder, a magnetic rotary encoder, an electromagnetic inductive rotary encoder, or a capacitive rotary encoder, but is not limited thereto.

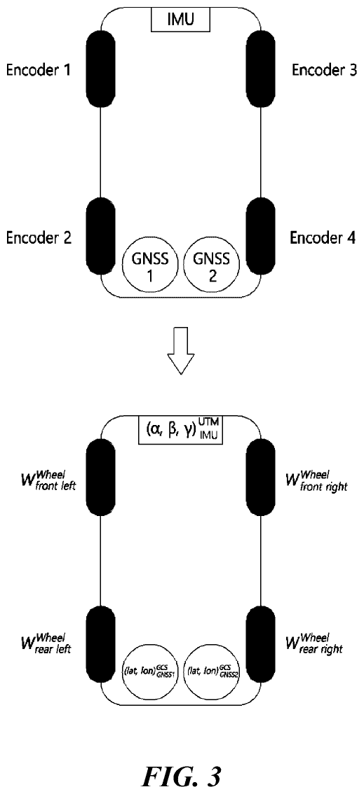

FIG. 3 illustrates an example of a measurement value or physical quantity output from each module of a positioning device according to an embodiment of the present disclosure.

Referring to FIG. 3, the positioning device according to the embodiment of the present disclosure may include a first GNSS module GNSS1 and a second GNSS module GNSS2 installed at two separate locations of a moving body, an IMU including an acceleration sensor and an angular velocity sensor installed at a specific location of the moving body, and wheel encoders including a first encoder Encoder1 to a fourth encoder Encoder4 installed at each of four wheels.

As shown in the right drawing of FIG. 3, GNSS1 and GNSS2 may output first longitude and latitude information

$${( lat , lon )}_{GNSS 1}^{GCS}$$

and second longitude and latitude information

$${( lat , lon )}_{GNSS 2}^{GCS} ,$$

respectively.

Meanwhile, the positioning module 140 according to the embodiment of the present disclosure may convert the first longitude and latitude information

$${( lat , lon )}_{GNSS 1}^{GCS}$$

and second longitude and latitude information

$${( lat , lon )}_{GNSS 2}^{GCS}$$

received from GNSS1 and GNSS2 into first UTM coordinate values

$${( x , y )}_{GNSS 1}^{UTM}$$

and second UTM coordinate values

$${( x , y )}_{GNSS 2}^{UTM}$$

corresponding to the position of a moving body in the UTM coordinate system.

In this case, the first UTM coordinate value and the second UTM coordinate value may be used as equivalent meanings to the first GNSS measurement value

$${( x , y )}_{GNSS 1}^{UTM}$$

and the second GNSS measurement value

$${( x , y )}_{GNSS 2}^{UTM} ,$$

respectively.

The IMU may output inertial measurement values

$${( α , β , γ )}_{IMU}^{UTM}$$

representing the roll (α), pitch (β), and yaw (γ) values of the moving body in the UTM coordinate system.

In addition, the first encoder Encoder1 to the fourth encoder Encoder4, which are wheel encoders, may each output wheel encoder measurement values

$${w}_{front left}^{Wheel} , {w}_{front right}^{Wheel} , {w}_{rear left}^{Wheel} , {w}_{rear right}^{Wheel} ,$$

which represent the rotation angles (or angular velocities) of the four wheels, respectively.

Meanwhile, the positioning module 140 of the positioning device 100 according to the embodiment of the present disclosure may determine first position information

$${( x , y , γ )}_{Fusion 1}^{UTM}$$

in a first area where a GNSS signal is received and second position information

$${( x , y , γ )}_{Fusion 2}^{U T M}$$

in a second area where a GNSS signal is not received by using the first GNSS measurement value

$${( x , y )}_{G N S S 1}^{U T M}$$

and the second GNSS measurement value

$${( x , y )}_{G N S S 2}^{U T M}$$

determined from the output signal from the GNSS module, the inertial measurement value

$${( α , β , γ )}_{IMU}^{U T M}$$

from the IMU, and the wheel encoding measurement value from the wheel encoder for two or more wheels.

As an example, the positioning module 140 of the positioning device 100 according to the embodiment of the present disclosure may also determine whether the current location of the moving body is located in the first area or the second area.

If the moving body is located in the first area, which is a signal reception area, the positioning module 140 may determine and output first position information based on a first fusion function (Fusion 1) having as parameters a forward kinematics output value

$${( x , y , γ )}_{R {obot}_{F K}}^{U T M}$$

calculated based on a wheel encoding measurement value and an inertial measurement value, the first GNSS measurement value or the second GNSS measurement value, and a yaw measurement value

$${( γ )}_{G N S S}^{U T M}$$

calculated based on the first GNSS measurement value and the second GNSS measurement value.

Meanwhile, when the moving body is located in the second area, which is a signal shadow area, the positioning module 140 may determine and output second position information based on the second fusion function (Fusion 2) having as parameters the aforementioned forward kinematics output value and the first position information determined in the first area.

Meanwhile, the first GNSS measurement value may be a first UTM coordinate value

$${( x , y )}_{GNSS 1}^{UTM}$$

obtained by converting the first latitude and longitude information

$${( l a t , l o n )}_{G N S S 1}^{G C S}$$

measured by the first GNSS module into the Universal Transverse Mercator (UTM) coordinate system, and the second GNSS measurement value may be a second UTM coordinate value

$${( x , y )}_{G N S S 2}^{U T M}$$

obtained by converting the second latitude and longitude information

$${( l a t , l o n )}_{G N S S 2}^{G C S}$$

measured by the second GNSS module into the UTM coordinate system.

In this case, the positioning module 140 may determine the yaw measurement value

$${( γ )}_{G N S S}^{U T M} ,$$

which is a parameter of the first fusion function, based on the first UTM coordinate value and the second UTM coordinate value.

In addition, the forward kinematics output value may be calculated based on the wheel encoding measurement values for the four wheels of the moving body and inertial measurement values, and may be expressed as UTM coordinate values (x, y) and a yaw value (γ).

This forward kinematics output value may be expressed as

$${( x , y , γ )}_{Robot \_ FK}^{U T M} .$$

In addition, the positioning module 140 may switch the output value from the first position information to the second position information if the moving body enters the second area from the first area, and may switch the output value from the second position information to the first position information if the moving body enters the first area from the second area.

In this case, the positioning module may verify the continuity of the position information during the switching.

For example, if the moving body enters the second area from the first area, the positioning module 140 may determine the identity or continuity between the final first position information determined last in the first area by the first fusion function and the initial second position information determined first by the second fusion function after entering the second area, and may perform a switching from the first position information to the second position information based on the determination result.

Similarly, if a moving body enters a first area from a second area, the positioning module 140 may determine the identity or continuity between the final second position information determined in the second area by the second fusion function and the initial first position information determined for the first time by the first fusion function after entering the first area, and may perform a switch from the second position information to the first position information based on the determination result.

By comparing and verifying the continuity or identity of the position information, positioning accuracy can be improved, and thus, continuity of vehicle control can be guaranteed.

When switching between the first and second position information, if the identity or continuity of the position information is not secured to a certain level, the positioning module 140 may apply a higher weight to the measured position information using the measurement values of the GNSS module. The detailed configuration of this positioning module 140 will be described in more detail below with reference to FIG. 4 and below.

FIG. 4 illustrates a signal processing process of a positioning device according to an embodiment of the present disclosure, and results from each process.

FIG. 4 illustrates functions performed by a positioning module 140 of a positioning device according to an embodiment of the present disclosure.

Referring to FIG. 4, the functions performed by the positioning module 140 may include a UTM conversion function, an angle calculation function, a forward kinematics function, an area determination function, a first position information determination function using a first fusion function, a second position information determination function using a second fusion function, and a position information switch function.

In this case, each function performed by the positioning module 140 may be implemented as a respective functional module within the positioning module.

Each functional module may be implemented as specific hardware, including circuits and filters, computer software, or a combination thereof.

FIG. 4 is a block diagram illustrating the functions performed by the positioning module 140, and for convenience, each function is expressed as a module in this specification.

Referring to FIG. 4, the UTM conversion module 142 of the positioning module 140 may receive first latitude and longitude information

$${( l a t , l o n )}_{G N S S 1}^{G C S}$$

from the first GNSS module and converts it into a first UTM coordinate value

$${( x , y )}_{G N S S 1}^{U T M}$$

within the UTM coordinate system, and receive second latitude and longitude information

$${( l a t , l o n )}_{G N S S 2}^{G C S}$$

from the second GNSS module and converts it into a second UTM coordinate value

$${( x , y )}_{GNSS 2}^{UTM} .$$

In this case, the first UTM coordinate value and the second UTM coordinate value may be used with the same meaning as the first GNSS measurement value

$${( x , y )}_{GNSS 1}^{UTM}$$

and the second GNSS measurement value

$${( x , y )}_{GNSS 2}^{UTM} ,$$

respectively.

The conversion from the first/second latitude and longitude information to the first/second UTM coordinate value can be expressed by the following Equation 1.

$${( x , y )}_{GNSS 1}^{UTM} = UTM Transformation ( {( lat , lon )}_{GNSS 1}^{GCS} ) \qquad [ Equation 1 ]$$

$${( x , y )}_{GNSS 2}^{UTM} = UTM Transformation ( {( lat , lon )}_{GNSS 2}^{GCS} )$$

In the Equation 1,

$${( lat , lon )}_{GNSS 1}^{GCS} and {( lat , lon )}_{GNSS 2}^{GCS}$$

may be first and second longitude and latitude information, respectively, and

$${( x , y )}_{GNSS 1}^{UTM} and {( x , y )}_{GNSS 2}^{UTM}$$

may be first and second UTM coordinate values.

For convenience, in the present disclosure,

$${( x , y )}_{GNSS 1}^{UTM} and {( x , y )}_{GNSS 2}^{UTM}$$

are used with the same meaning as the first UTM coordinate value and the second UTM coordinate value, or the first GNSS measurement value and the second GNSS measurement value.

In Equation 1, TM Transformation may be a function that converts longitude and latitude coordinates into UTM coordinates, and a general-purpose GNSS-to-UTM function can be used therefor.

The angle calculation module (Angle Calculator) 143 of the positioning module 140 may calculate

$${( γ )}_{GNSS}^{UTM} ,$$

which is a yaw measurement value of a moving body, using the first UTM coordinate value

$${( x , y )}_{GNSS 1}^{UTM}$$

and the second UTM coordinate value

$${( x , y )}_{GNSS 2}^{UTM}$$

determined by the UTM conversion module 142.

In this case, the yaw measurement value

$${( γ )}_{GNSS}^{UTM}$$

can be determined using Equation 2 below.

$${( γ )}_{GNSS}^{UTM} = aran 2 ( {y}_{2}^{UTM} - {y}_{1}^{UTM} , {x}_{2}^{UTM} - {x}_{1}^{UTM} ) \qquad [ Equation 2 ]$$

Here, (x1,y1) and (x2,y2) may be the two first UTM coordinate values

$${( x , y )}_{GNSS 1}^{UTM}$$

or the two second UTM coordinate values

$${( x , y )}_{GNSS 2}^{UTM}$$

determined by the UTM conversion module 142 at the first/second time point, respectively.

The yaw measurement value

$${( γ )}_{GNSS}^{UTM}$$

determined by the angle calculation module 143 may refer to the yaw angle or heading angle, which is the moving direction of the moving body in the UTM coordinate system.

The forward kinematics module 144 of the positioning module 140 may calculate a forward kinematics output value representing the position and behavior of the moving body based on the wheel encoding measurement values

$${w}_{front left}^{Wheel} , {w}_{front right}^{Wheel} , {w}_{rear left}^{Wheel} , {w}_{rear right}^{Wheel}$$

and the inertial measurement values

$${( α , β , γ )}_{IMU}^{UTM} .$$

The forward kinematics output value may be expressed as

$${( x , y , γ )}_{Robot\_FK}^{UTM} ,$$

and may include the position coordinates (x,y) of the moving body in the UTM coordinate system, and the yaw value (γ), which is the moving direction of the moving body at that position.

This forward kinematics calculation can be performed using the following Equation 3.

$${( x , y , γ )}_{Robot\_FK}^{UTM} = Forward Kinematics ( {w}_{front left}^{Wheel} , {w}_{front right}^{Wheel} , {w}_{rear left}^{Wheel} , {w}_{rear right}^{Wheel} , {( α , β , γ )}_{IMU}^{UTM} ) \qquad [ Equation 3 ]$$

The forward kinematics function in Equation 3 may be described as Equations 4-1 to 4-4 below.

First, the variables for defining the forward kinematics function may be as shown in Table 1 below.

TABLE 1

| Variable | Meaning | Unit |
|---|---|---|
| ω_{fl}, ωᵣₗ, ω_{fr}, ωᵣᵣ | wheel angular velocity (front/rear/left/right) | rad/s |
| ω_{L}, ω_{R} | Left and right average wheel angular velocity | rad/s |
| v_{L}, v_{R} | Left and right linear speed | m/s |
| v^{B} | Body linear velocity (forward) | m/s |
| \dot{γ}^{B} | | rad/s |
| Δx^{B}, Δy^{B} | Body linear velocity (yaw rate) | m |
| Δγ^{B} | One-step distance traveled (body frame) | rad |
| R | Wheel radius | m |
| W | Vehicle width (track width) | m |
| Δt | Sampling period | s |
| T(•) | SE(2) transformation matrix function | — |

In the description below, superscripts may indicate the coordinate system in which data is expressed, while subscripts may indicate the left and right and up and down of the wheels, and the measurement system (e.g., GNSS, IMU, etc.) from which the data is generated.

For example, the superscript B may indicate a coordinate system based on the robot body frame as a moving body, i.e., a moving body reference coordinate system, and the superscript U or UTM may indicate a UTM Grid-North world coordinate system.

Additionally, the subscript S or GNSS may indicate a GNSS sensor frame, and the subscript B or Robot may indicate a moving body frame.

The positioning module 140 can determine the linear velocity v^{B} and the angular velocity or yaw rate γ^{B} of the moving body based on the wheel speed w from the wheel encoding measurement to determine the forward kinematics function, using Equation 4-1 below.

$$\begin{matrix}{ω}_{L} = \frac{{ω}_{fl} + {ω}_{el}}{2} , & {ω}_{R} = \frac{{ω}_{fr} - {ω}_{rr}}{2} \\ {v}_{L} = R {ω}_{L} , & {v}_{R} = R {ω}_{R} \\ {v}^{B} = \frac{{v}_{L} + {v}_{R}}{2} , & {\dot{γ}}^{B} = \frac{{v}_{R} + {v}_{L}}{W}\end{matrix} \qquad [ Equation 4 - 1 ]$$

Next, the one-step distance or one-step displacement in the moving body frame may be determined using Equation 4-2 below.

$$Δ {x}^{B} = {v}^{B} Δ t cos {γ}_{k}^{B} , Δ {y}^{B} = {v}^{B} Δ t sin {γ}_{k}^{B} , {Δγ}^{B} = {\dot{γ}}^{B} Δ t \qquad [ Equation 4 - 2 ]$$

In this case, the incremental transformation matrix may be determined using Equation 4-3 below.

$$Δ {T}_{DR}^{B} = T ( Δ {x}^{B} , Δ {y}^{B} , Δ {γ}^{B} ) \qquad [ Equation 4 - 3 ]$$

The positioning module 140 may apply the incremental transformation matrix to the forward kinematics output value

$${T}_{ℬ , k}^{𝒰}$$

at the previous time point (K) and determine the forward kinematics output value

$${T}_{ℬ , k + 1}^{𝒰}$$

at the current time point (k+1) using Equation 4-4 below.

$${T}_{ℬ , k + 1}^{𝒰} = {T}_{ℬ , k}^{𝒰} Δ {T}_{DR}^{ℬ} \qquad [ Equation 4 - 4 ]$$

As described above, there has been described a method for calculating the forward kinematics output value

$${T}_{ℬ , k + 1}^{𝒰}$$

at the current point (k+1) using the forward kinematics function.

The area determination module of the positioning module 140 may determine whether the moving body is in a first area where GNSS signals can be received, based on the current location of the moving body and whether a signal is received from a GNSS module.

For example, the area determination module may determine that the moving body is in the first area if the current location of the moving body is not in a signal shadow area such as a tunnel using map information.

Alternatively, the area determination module may determine that the moving body is in the first area if longitude and latitude output values are output from both GNSS modules.

Meanwhile, the area determination module may determine that the moving body is in a second area, which is a signal shadow area, if longitude and latitude output values are not output from at least one of the two GNSS modules, or if the current location of the moving body is in a signal shadow area such as a tunnel using map information.

If the moving body is in the first area which is the signal reception area, the first position information determination module 145 of the positioning module 140 may determine the first position information of the moving body based on the first fusion function (Fusion 1) having as parameters the forward kinematics output value

$${( x , y , γ )}_{Robot\_FK}^{UTM}$$

by the Equations 3 and 4, the first GNSS measurement value (e.g., the first UTM coordinate value)

$${( x , y )}_{GNSS 1}^{UTM}$$

or the second GNSS measurement value (e.g., the second UTM coordinate value)

$${( x , y )}_{GNSS 2}^{UTM} ,$$

and the yaw measurement value

$${( γ )}_{GNSS}^{UTM}$$

calculated by the angle calculation module.

The first position information of the moving body in the signal reception area (i.e., the first area) determined by the first fusion function can be expressed as

$${( x , y , γ )}_{F u sion 1}^{U T M} ,$$

and the determination of the first position information can be expressed by the following Equation 5.

$${( x , y , γ )}_{F u sion 1}^{U T M} = Fusion 1 ( {( x , y , γ )}_{Robot \_ FK}^{UTM} , {( x , y )}_{GNSS 1}^{UTM} , {( γ )}_{GNSS}^{UTM} )$$

In Equation 5, the first position information

$${( x , y , γ )}_{F u sion 1}^{U T M} or {T}_{ℬ , k + 1}^{𝒰}$$

at the current time point (k+1) determined by the first fusion function (Fusion 1) may be defined as the following Equation 6.

$${T}_{ℬ , k}^{𝒰} ← Δ {T}_{ℬ}^{𝒰} ( when updating GNSS )$$

$${T}_{ℬ , k + 1}^{𝒰} = {T}_{ℬ , k}^{𝒰} Δ {T}_{DR}^{ℬ}$$

According to the Equation 6, if a moving body is in a first area, which is a GNSS signal reception area, the first position information determination module 145 of the positioning module 140 may determine the first position information

$${( x , y , γ )}_{F u sion 1}^{U T M} or {T}_{ℬ , k + 1}^{𝒰}$$

of the moving body at the current point in time (k+1) by applying the incremental transformation matrix

$$Δ {T}_{DR}^{ℬ}$$

described above to the updated GNSS position information

$${T}_{ℬ , k}^{𝒰}$$

when the position information is updated.

Meanwhile, if the moving body is in the second area, which is a signal shadow area, the second position information determination module 146 of the positioning module 140 can determine the second position information of the moving body based on the second fusion function (Fusion 2) having the forward kinematics output value

$${( x , y , γ )}_{Robot \_ FK}^{UTM}$$

by Equations 3 and 4 and the first position information determined by the first position information determination module as parameters.

The second position information of the moving body in the signal shadow area (i.e., the second area), determined by the second fusion function, may be expressed as

$${( x , y , γ )}_{F u sion 2}^{U T M} ,$$

and the determination of the second position information may be expressed by Equation 7 below.

$${( x , y , γ )}_{F u sion 2}^{U T M} = Fusion 2 ( {( x , y , γ )}_{Robot \_ FK}^{UTM} , {( x , y , γ )}_{{Robot}_{Init}}^{UTM} ) \qquad [ Equation 7 ]$$

In Equation 7, the second position information

$${( x , y , γ )}_{F u sion 2}^{U T M} or {T}_{ℬ , k + 1}^{𝒰}$$

of the moving body at the current point (k+1) determined by the second fusion function (Fusion 2) may be defined as in Equation 8 below.

$$\begin{matrix}{T}_{ℬ , {k}_{0}}^{𝒰} ← Δ {T}_{ℬ , {k}_{0} - 1}^{𝒰} \\ {T}_{ℬ , k + 1}^{𝒰} = {T}_{ℬ , k}^{𝒰} Δ {T}_{DR}^{ℬ}\end{matrix} \qquad [ Equation 8 ]$$

According to the Equation 8, if a moving body enters a second area, which is a signal shadow area, from a first area as a signal reception area, the second position information determination module 146 of the positioning module 140 may determine the second position information

$${( x , y , γ )}_{F u sion 2}^{U T M} or {T}_{ℬ , k + 1}^{𝒰}$$

of the moving body at the current point (k+1) by cumulatively applying the incremental transformation matrix

$$Δ {T}_{DR}^{ℬ}$$

described above to the first position information

$${( x , y , γ )}_{{Robot}_{Init}}^{UTM} or {T}_{ℬ , {k}_{0}}^{𝒰} ,$$

which is finally determined in the first area as the signal reception area.

That is, the first position information

$${( x , y , γ )}_{{Robot}_{Init}}^{UTM} or {T}_{ℬ , {k}_{0}}^{𝒰} ,$$

in Equations 7 and 8, may be the first position information finally determined in the first area immediately before the moving body enters the second area.

That is, the second position information in the second area, which is a signal shadow area, may be determined using a second fusion function that uses the first position information, which is the final location in the signal reception area, as an initial value.

Meanwhile, the switch module 147 of the positioning module 140 may perform a function of selecting and outputting the first position information or the second position information according to the location of the moving body.

For example, if the moving body is in the first area, which is a signal reception area, the switch module 147 may output the first position information from the first position information determination module 145.

Furthermore, if the moving body is in the second area, which is a signal shadow area, the switch module 147 may output the second position information from the second position information determination module 146.

As another example, the switch module 147 may switch the output value from the first position information to the second position information if the moving body enters the first area from the first area, and may switch the output value from the second position information to the first position information if the moving body enters the first area from the second area.

As described above, the switch module 147 may perform a comparative verification of the continuity or identity of the first and second position information when entering the first and second areas.

As an example, when switching the first and second position information, if the identity or continuity of the position information is not secured above a specific level, the switch module 147 may apply a higher weight to the measured position information using the measurement values of the GNSS module.

The position information of the moving body output from the switch module 147 may be transmitted to the autonomous driving control module of the moving body.

The autonomous driving control module of a moving body may control the moving body to drive along a target path for autonomous driving by rotating the wheels provided in the moving body based on the position information of the moving body received from the switch module.

According to the positioning device according to the embodiments of the present disclosure as described above, precise position information can be calculated for a moving body, such as a vehicle or robot, in both indoor and outdoor environments.

Furthermore, according to the positioning device according to the embodiments of the present disclosure, precise position information of the moving body can be calculated even in areas where GNSS signals are shadowed, using information from two GNSS modules, an IMU device, and a wheel encoder provided in the moving body.

Through this, the completeness of autonomous driving of the moving body can be ensured.

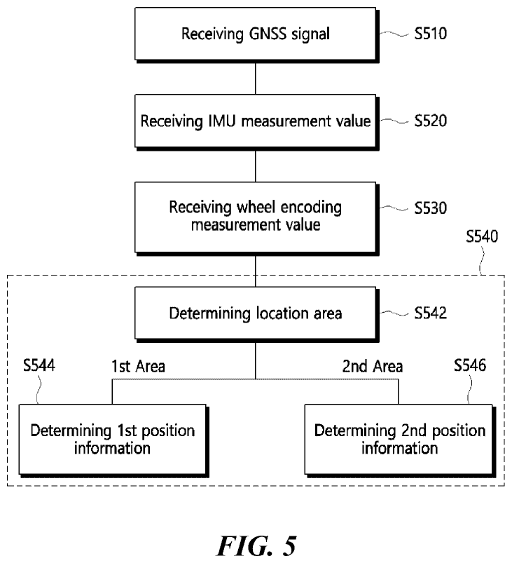

FIG. 5 is a flowchart of a positioning method according to an embodiment of the present disclosure.

Referring to FIG. 5, the positioning method according to an embodiment of the present disclosure may include a GNSS signal receiving step (S510), an IMU measurement value receiving step (S520), a wheel encoding measurement value receiving step (S530), and a position information determination step (S540).

The positioning method as shown in FIG. 5 may be performed using the positioning device described in FIGS. 2 to 4.

Each step of the positioning method according to an embodiment of the present disclosure is described in detail as follows.

In the GNSS signal receiving step (S510), the positioning module of the positioning device may receive first longitude and latitude information

$${( lat , lon )}_{GNSS 1}^{GCS}$$

from the first GNSS module GNSS1, and second longitude and latitude information

$${( lat , lon )}_{GNSS 2}^{GCS}$$

from the second GNSS module GNSS2.

In the IMU measurement value receiving step (S520), the positioning module of the positioning device may receive inertial measurement values

$${( α , β , γ )}_{IMU}^{UTM}$$

from the IMU.

In the wheel encoding measurement value receiving step (S530), the positioning module of the positioning device may receive wheel encoding measurement values

$$( e . g . , {w}_{front left}^{Wheel} , {w}_{front right}^{Wheel} , {w}_{rear left}^{Wheel} , {w}_{rear right}^{Wheel} )$$

from two or more wheel encoders that detect the amount of rotation of the wheels of the moving body.

In the position information determination step (S540), the positioning module of the positioning device may determine the first position information

$${( x , y , γ )}_{Fusion 1}^{UTM}$$

in a first area where a GNSS signal is received and the second position information

$${( x , y , γ )}_{Fusion 2}^{UTM}$$

in a second area where a GNSS signal is not received can be determined, respectively, by using the first GNSS measurement value

$${( x , y )}_{GNSS 1}^{UTM}$$

and the second GNSS measurement value

$${( x , y )}_{GNSS 2}^{UTM}$$

based on the first latitude and longitude information

$${( lat , lon )}_{GNSS 1}^{GCS}$$

and the second latitude and longitude information

$${( lat , lon )}_{GNSS 2}^{GCS} ,$$

the inertial measurement values

$${( α , β , γ )}_{IMU}^{UTM} ,$$

and the wheel encoding measurement values from the wheel encoders for two or more wheels.

As an example, referring to FIG. 5, the position information determination step (S540) may include an area determination step (S542) for determining an area in which a moving body exists, a first position information determination step (S544) for determining first position information if the moving body is located in a first area, which is a signal reception area, and a second position information determination step (S546) for determining second position information if the moving body is located in a second area, which is a signal shadow area.

In the area determination step (S542), the positioning module may determine whether the moving body is in a first area where GNSS signals can be received or a second area where GNSS signals cannot be received, based on map information, the current location of the moving body, whether a signal has been received from a GNSS module, etc.

In the first position information determination step (S544), the positioning module may calculate the first position information based on a first fusion function (Fusion 1) having as parameters a forward kinematics output value

$${( x , y , γ )}_{Robot \_ FK}^{UTM}$$

calculated based on the wheel encoding measurement value and the inertial measurement value, the first GNSS measurement value or the second GNSS measurement value, and a yaw measurement value

$${( γ )}_{GNSS}^{UTM}$$

calculated based on and the first GNSS measurement value and the second GNSS measurement value.

In this case, the first GNSS measurement value may be a first UTM coordinate value

$${( x , y )}_{GNSS 1}^{UTM}$$

obtained by converting the first latitude and longitude information

$${( lat , lon )}_{GNSS 1}^{GCS}$$

into a UTM coordinate system, and the second GNSS measurement value may be a second UTM coordinate value

$${( x , y )}_{GNSS 2}^{UTM}$$

obtained by converting the second latitude and longitude information

$${( lat , lon )}_{GNSS 2}^{GCS}$$

into a UTM coordinate system.

In addition, the yaw measurement value

$${( γ )}_{GNSS}^{UTM}$$

may be determined by the positioning module based on the first UTM coordinate value and the second UTM coordinate value.

In addition, the forward kinematics output value

$${( x , y , γ )}_{Robot \_ FK}^{UTM}$$

may be calculated based on the wheel encoding measurement values

$${w}_{front left}^{Wheel} , {w}_{front right}^{Wheel} , {w}_{rear left}^{Wheel} , {w}_{rear left}^{Wheel}$$

for the four wheels of the moving body and the inertial measurement values

$${( α , β , γ )}_{IMU}^{UTM} ,$$

and may be expressed as UTM coordinate values (x, y) and yaw values (γ).

Meanwhile, in the second position information determination step (S546), the positioning module may calculate the second position information of the moving body based on the second fusion function (Fusion 2) having the forward kinematics output value

$${( x , y , γ )}_{Robot \_ FK}^{UTM}$$

and the first position information

$${( x , y , γ )}_{{Robot}_{Init}}^{UTM}$$

as parameters.

The first fusion function (Fusion 1) and the second fusion function (Fusion 2) may be defined by the Equations 5 to 8 described above, but are not limited thereto.

In addition, the positioning method according to an embodiment of the present disclosure may further include a position information switching step (S550).

In the position information switching step (S550), if a moving body enters a second area from a first area, the positioning module may switch the output value from the first position information to the second position information, and if the moving body enters the first area from the second area, the positioning module may switch the output value from the second position information to the first position information.

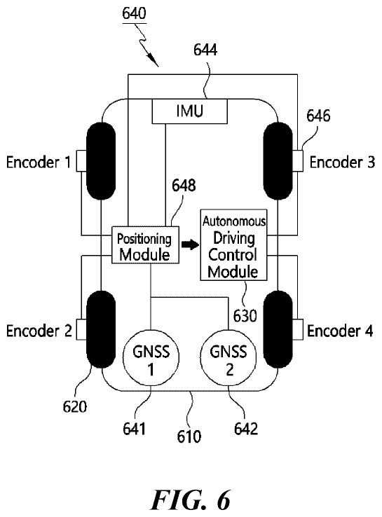

FIG. 6 illustrates a functional block diagram of a moving body according to an embodiment of the present disclosure.

A moving body according to an embodiment of the present disclosure may include any moving body capable of autonomous navigation, such as an autonomous vehicle or an outdoor autonomous navigation robot.

While FIG. 6 illustrates a vehicle as an example, the present disclosure is not limited thereto.

Referring to FIG. 6, a moving body according to an embodiment of the present disclosure may include a main body 610, two or more wheels 620 provided on the main body, an autonomous driving control module 630 that rotates the wheels to move the main body along a target path, and a positioning device 640 that measures the current position of the main body.

The autonomous driving control module 630 may control the moving body to drive the wheels of the moving body based on position information from the positioning device, thereby driving the moving body along a destination or target path.

The positioning device 640 may include a configuration corresponding to the positioning devices described in FIGS. 2 to 4.

As an example, a positioning device 640 provided in a moving body according to an embodiment of the present disclosure may include a first GNSS module 641 and a second GNSS module 642, a measuring device including an IMU 644 and a wheel encoder 646, and a positioning module 648 that determines the position of the moving body based on each piece of information of the measuring device.

The positioning module 648 may use the first GNSS measurement value

$${( x , y )}_{GNSS 1}^{UTM}$$

and the second GNSS measurement value

$${( x , y )}_{GNSS 2}^{UTM}$$

determined based on the signal from the GNSS module, the inertial measurement value

$${( α , β , γ )}_{IMU}^{UTM}$$

from the IMU, and the wheel encoding measurement value from the wheel encoder for two or more wheels to calculate the first position information

$${( x , y , γ )}_{Fusion 1}^{UTM}$$

in the first area where the GNSS signal is received, and the second position information

$${( x , y , γ )}_{Fusion 2}^{UTM}$$

in the second area where the GNSS signal is not received, respectively.

In addition, the positioning module 648 may determine whether the current position of the moving body is located in the first area or the second area.

If the moving body is located in the first area, the positioning module 648 may calculate the first position information

$${( x , y , γ )}_{Fusion 1}^{UTM}$$

based on a first fusion function (Fusion 1) having as parameters a forward kinematics output value

$${( x , y , γ )}_{Robot \_ FK}^{U T M}$$

calculated based on the wheel encoding measurement value and the inertial measurement value, the first GNSS measurement value or the second GNSS measurement value, and a yaw measurement value

$${( γ )}_{G N S S}^{U T M}$$

calculated based on the first GNSS measurement value and the second GNSS measurement value.

In addition, if the moving body is located in the second area, the second position information

$${( x , y , γ )}_{Fusion 2}^{U T M}$$

can be determined based on the second fusion function (Fusion 2) having the forward kinematics output value and the first position information

$${( x , y , γ )}_{R {obot}_{Init}}^{U T M}$$

as parameters.

In this case, the configuration for calculating the first GNSS measurement value

$${( x , y )}_{G NSS 1}^{U T M}$$

and the second GNSS measurement value

$${( x , y )}_{G NSS 2}^{U T M}$$

based on the latitude and longitude position information output from the GNSS, the configuration for determining the yaw measurement value

$${( γ )}_{G N S S}^{U T M} ,$$

the configuration for calculating the forward kinematics output value, the configuration for determining the first position information

$${( x , y , γ )}_{F u s ion 1}^{U T M}$$

using the first fusion function, and the configuration for determining the second position information

$${( x , y , γ )}_{Fusion 2}^{U T M}$$

using the second fusion function may correspond to the configuration described using Equations 1 to 8 above, and therefore, a detailed description thereof is omitted to avoid duplication.

In addition, the positioning module 648 may further perform a function of switching the output value from the first position information to the second position information if the moving body enters the second area from the first area, and switching the output value from the second position information to the first position information if the moving body enters the first area from the second area.

The autonomous driving control module 630 may control the main body 610 to drive along a target path for autonomous driving by rotating the wheel 620 provided on the main body 610 based on the position information of the moving body received from the positioning module 648.

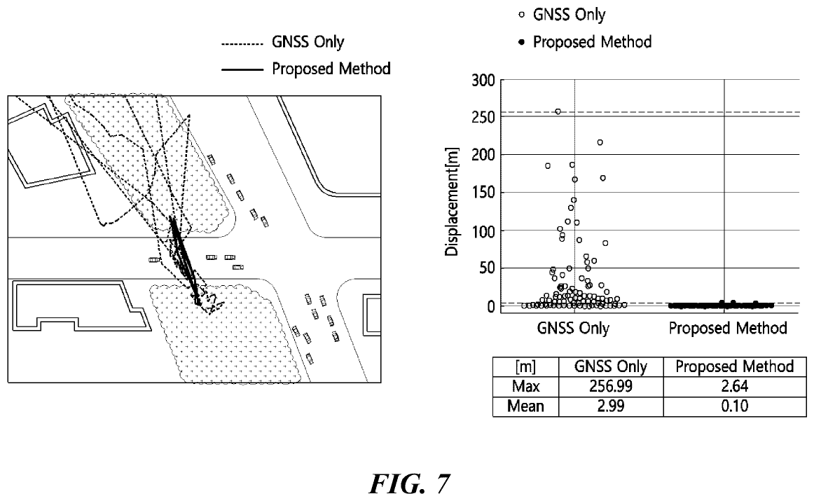

FIG. 7 is a diagram illustrating the positioning performance when an embodiment of the present disclosure is applied.

FIG. 7 represents position information determined using only GNSS as a dotted line and position information using positioning according to an embodiment of the present disclosure as a solid line in the case that a moving body travels through an outdoor area such as a road (e.g., a first area) and a signal shadow area such as a tunnel (e.g., a second area) over time.

In this case, as shown in the graph and table on the right side of FIG. 7, the displacement between the positioning information using only GNSS and the actual location ranges from tens to hundreds of meters, whereas the displacement is almost zero when using the positioning method according to an embodiment of the present disclosure.

According to experiments, the maximum displacement of the positioning information using only GNSS was 256.99 meters, and the average displacement was approximately 2.99 meters. However, when using the positioning method according to an embodiment of the present disclosure, the maximum displacement of the positioning information was 2.64 meters, and the average displacement was approximately 0.10 meters.

Therefore, according to the positioning method according to the embodiment of the present disclosure, accurate positioning is possible even in areas where GNSS signals are not received.

According to the positioning device of the embodiments of the present disclosure as described above, precise position information can be calculated for a moving body, such as a vehicle or robot, in both indoor and outdoor environments.

Furthermore, using the positioning device according to the embodiments of the present disclosure, precise position information of the moving body can be calculated even in areas where GNSS signals are not received, using information from two GNSS modules, an IMU device, and a wheel encoder provided in the moving body, thereby enabling autonomous navigation of the moving body regardless of the environment.

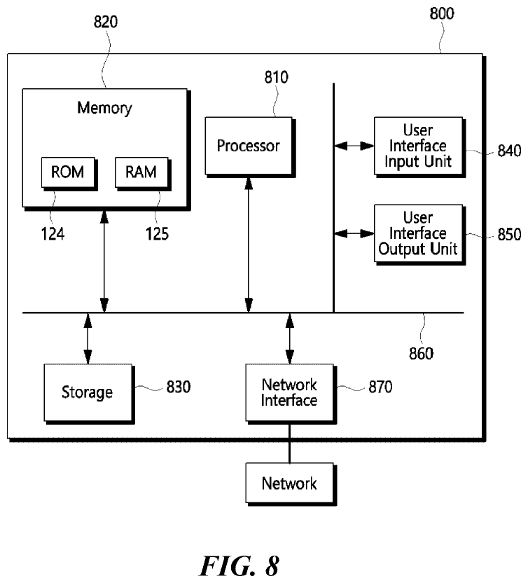

FIG. 8 illustrates an example of the hardware configuration of a positioning module according to an embodiment of the present disclosure.

The positioning module of the positioning device may be implemented as hardware components such as circuits and filters, but may also be implemented as specific hardware or software implemented within a computer system.

That is, the positioning device or the positioning module included therein may be implemented as a computer device having hardware such as that illustrated in FIG. 8.

As illustrated in FIG. 8, a computer system 800, which is an implementation form of the positioning device or the positioning module included therein according to the present embodiment, may include at least one or more elements of one or more processors 810, a memory 820, a storage 830, a user interface input unit 840, and a user interface output unit 850, which may communicate with each other via a bus 860.

In addition, the computer system 800 may also include a network interface 870 for connecting to a network. The network interface 870 may be a Controller Area Network (CAN) for in-vehicle communication.

The processor 810 may be a CPU or semiconductor device that executes processing instructions stored in the memory 820 and/or storage 830.

The memory 820 and storage 830 may include various types of volatile/non-volatile storage media. For example, the memory may include a ROM 821 and a RAM 823.

Additionally, the computer system 800 used in this embodiment may be installed with a software module for performing the functions of the positioning module according to this embodiment.

Specifically, a software module for converting latitude and longitude information of GNSS into coordinate values of a UTM coordinate system, a software module for calculating a yaw measurement value of a moving body based on UTM coordinate values by two GNSS, a software module for calculating a forward kinematics output value indicating the position and behavior of the moving body based on wheel encoding measurement values and inertial measurement values, a software module for determining an area in which the moving body exists based on map information, moving body position information, and whether or not a GNSS signal is received, a software module for determining first position information by a first fusion function, a software module for determining second position information by a second fusion function, and a software module for performing a position information switch according to the position of the moving body may be installed in the computer system 800.

The processor (e.g., MCU) 810 of the computer system according to the present embodiment may execute the aforementioned software module stored in the storage 830 or the memory 820 to perform a corresponding function.

Even though all components constituting the embodiments of the present disclosure have been described as being combined or operating in combination as one, the present disclosure is not necessarily limited to these embodiments. That is, within the scope of the purpose of the present disclosure, all components may be selectively combined and operated one or more times. In addition, although all components may be implemented as individual independent hardware, some or all of the components may be selectively combined and implemented as a computer program having program modules that perform some or all of the functions combined in one or more hardware pieces. The codes and code segments constituting the computer program may be easily inferred by those skilled in the art of the present disclosure. Such a computer program may be stored in a computer-readable storage medium and read and executed by a computer, thereby implementing the embodiments of the present disclosure. Storage media for the computer program may include a magnetic recording medium, an optical recording medium, a carrier wave medium, etc.

In addition, terms such as “include,” “comprise,” or “have” described above, unless specifically stated otherwise, mean that the corresponding component may be included, and therefore should be interpreted as including other components rather than excluding other components. All terms, including technical or scientific terms, have the same meaning as commonly understood by a person of ordinary skill in the art to which this disclosure pertains, unless otherwise defined. Commonly used terms, such as terms defined in a dictionary, should be interpreted as being consistent with the contextual meaning of the relevant technology, and shall not be interpreted in an ideal or excessively formal sense, unless explicitly defined in this disclosure.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A positioning device comprising:
a global navigation satellite system (GNSS) module including a first GNSS module and a second GNSS module;
an inertial measurement unit (IMU) including an acceleration sensor and an angular velocity sensor;
a wheel encoder configured to detect an amount of rotation of two or more wheels of a moving body; and
a positioning module configured to determine first position information in a first area where a GNSS signal is received and second position information in a second area where the GNSS signal is not received, respectively, using a first GNSS measurement value and a second GNSS measurement value determined based on GNSS signals from the GNSS module, inertial measurement values from the IMU, and wheel encoding measurement values from the wheel encoder for two or more wheels.

2. The positioning device of claim 1, wherein the positioning module determines whether the moving body is located in the first area or the second area,
wherein the positioning module determines, based on the moving body being located in the first area, the first position information based on a first fusion function having as parameters a forward kinematics output value calculated based on the wheel encoding measurement value and the inertial measurement value, the first GNSS measurement value or the second GNSS measurement value, and a yaw measurement value calculated based on the first GNSS measurement value and the second GNSS measurement value.

3. The positioning device of claim 2, wherein, based on the moving body being located in the second area, the positioning module determines the second position information based on a second fusion function having the forward kinematics output value and the first position information as parameters.

4. The positioning device of claim 3, wherein the first GNSS measurement value is a first Universal Transverse Mercator (UTM) coordinate value obtained by converting first latitude and longitude information measured by the first GNSS module into a UTM coordinate system, and the second GNSS measurement value is a second UTM coordinate value obtained by converting second latitude and longitude information measured by the second GNSS module into the UTM coordinate system, and
wherein the yaw measurement value is determined based on the first UTM coordinate value and the second UTM coordinate value.

5. The positioning device of claim 4, wherein the forward kinematics output value is calculated based on the wheel encoding measurement value for four wheels of the moving body and the inertial measurement value, and is expressed as a UTM coordinate value (x, y) and a yaw value (γ).

6. The positioning device of claim 5, wherein the first position information by the first fusion function and the second position information by the second fusion function are determined by applying an incremental transformation matrix to position information at a previous point in time.

7. The positioning device of claim 3, wherein the positioning module switches an output value from the first position information to the second position information based on the moving body entering the second area from the first area, and the positioning module switches the output value from the second position information to the first position information if the moving body enters the first area from the second area.

8. A positioning method comprising:
receiving first latitude and longitude information from a first global navigation satellite system (GNSS) module and second latitude and longitude information from a second GNSS module;
receiving inertial measurement values from an inertial measurement unit (IMU);
receiving wheel encoding measurement values from a wheel encoder that is configured to detect an amount of rotation of two or more wheels of a moving body; and
determining first position information in a first area where a GNSS signal is received and second position information in a second area where the GNSS signal is not received, respectively, using a first GNSS measurement value and a second GNSS measurement value determined based on the first latitude and longitude information and the second latitude and longitude information, the inertial measurement values, and the wheel encoding measurement values from the wheel encoder for two or more wheels.

9. The positioning method of claim 8, wherein the determining includes:
determining whether the moving body is located in the first area or the second area; and
determining, based on the moving body being located in the first area, the first position information based on a first fusion function having as parameters a forward kinematics output value calculated based on the wheel encoding measurement value and the inertial measurement value, the first GNSS measurement value or the second GNSS measurement value, and a yaw measurement value calculated based on the first GNSS measurement value and the second GNSS measurement value.

10. The positioning method of claim 9, further comprising: determining, based on the moving body being located in the second area, the second position information based on a second fusion function having the forward kinematics output value and the first position information as parameters.

11. The positioning method of claim 10, wherein the first GNSS measurement value is a first Universal Transverse Mercator (UTM) coordinate value obtained by converting first latitude and longitude information measured by the first GNSS module into a UTM coordinate system, and the second GNSS measurement value is a second UTM coordinate value obtained by converting second latitude and longitude information measured by the second GNSS module into the UTM coordinate system, and
wherein the yaw measurement value is determined based on the first UTM coordinate value and the second UTM coordinate value.

12. The positioning method of claim 11, wherein the forward kinematics output value is calculated based on the wheel encoding measurement value for four wheels of the moving body and the inertial measurement value, and is expressed as a UTM coordinate value (x, y) and a yaw value (γ).

13. The positioning method of claim 12, wherein the first position information by the first fusion function and the second position information by the second fusion function are determined by applying an incremental transformation matrix to position information at a previous point in time.

14. The positioning method of claim 10, wherein the determining includes:
switching an output value from the first position information to the second position information based on the moving body entering the second area from the first area; and
switching the output value from the second position information to the first position information based on the moving body entering the first area from the second area.

15. A moving body comprising:
a main body;
two or more wheels provided on the main body;
an autonomous driving control module that rotates the two or more wheels to move the main body along a target path; and
a positioning device that measures the current position of the main body,
wherein the positioning device comprises:
a global navigation satellite system (GNSS) module including a first GNSS module and a second GNSS module;
an inertial measurement unit (IMU) including an acceleration sensor and an angular velocity sensor;
a wheel encoder for detecting an amount of rotation of the two or more wheels; and
a positioning module configured to determine first position information in a first area where a GNSS signal is received and second position information in a second area where the GNSS signal is not received, respectively, using a first GNSS measurement value and a second GNSS measurement value determined based on GNSS signals from the GNSS module, inertial measurement values from the IMU, and wheel encoding measurement values from the wheel encoder for the two or more wheels.

16. The moving body of claim 15, wherein the positioning module determines whether the moving body is located in the first area or the second area,
wherein the positioning module determines, based on the moving body being located in the first area, the first position information based on a first fusion function having as parameters a forward kinematics output value calculated based on the wheel encoding measurement value and the inertial measurement value, the first GNSS measurement value or the second GNSS measurement value, and a yaw measurement value calculated based on the first GNSS measurement value and the second GNSS measurement value.

17. The moving body of claim 16, wherein, based on the moving body being located in the second area, the positioning module determines the second position information based on a second fusion function having the forward kinematics output value and the first position information as parameters.

18. The moving body of claim 17, wherein the first GNSS measurement value is a first Universal Transverse Mercator (UTM) coordinate value obtained by converting first latitude and longitude information measured by the first GNSS module into a UTM coordinate system, and the second GNSS measurement value is a second UTM coordinate value obtained by converting second latitude and longitude information measured by the second GNSS module into the UTM coordinate system, and
wherein the yaw measurement value is determined based on the first UTM coordinate value and the second UTM coordinate value.

19. The moving body of claim 18, wherein the forward kinematics output value is calculated based on the wheel encoding measurement value for four wheels of the moving body and the inertial measurement value, and is expressed as a UTM coordinate value (x, y) and a yaw value (γ).

20. The moving body of claim 17, wherein the first position information by the first fusion function and the second position information by the second fusion function are determined by applying an incremental transformation matrix to position information at a previous point in time.
